(19) United States
(12) Patent Application Publication
(10) Pub. No.: US 2025/0150264 A1
(43) Pub. Date: May 8, 2025

(54) SYSTEMS AND METHODS TO TRANSFER HIGH ENTROPY KEYS

(71) Applicant: Dashlane SAS, Paris (FR)

(72) Inventors: Mohammed Ruhul Islam, Taverny (FR); Guillaume Maron, Paris (FR); Ludovic Widmer, Clichy (FR); Quentin Barbe, Montrouge (FR); Frédéric Rivain, Brooklyn, NY (US)

(73) Assignee: Dashlane SAS, Paris (FR)

(21) Appl. No.: 18/906,749

(22) Filed: Oct. 4, 2024

Related U.S. Application Data
(60) Provisional application No. 63/595,876, filed on Nov. 3, 2023.

(51) Int. Cl. H04L 9/08; H04L 9/30

(52) U.S. Cl. CPC H04L 9/0841; H04L 9/0819; H04L 9/3073

(57) ABSTRACT

Novel tools and techniques are provided for implementing transfer of high entropy keys. In examples, a trusted device may generate a first key pair including a first ephemeral public key and a first ephemeral private key. A camera of the trusted device may capture a graphic code displayed by an untrusted device. The trusted device may extract a second ephemeral public key from the graphic code. The trusted device may generate a first instance of a symmetric key based on the first ephemeral private key and the second ephemeral public key, and may encrypt a high entropy key with the first instance of the symmetric key. The trusted device may send the encrypted high entropy key and the first ephemeral public key to a server for transfer to the untrusted device, which may decrypt the encrypted high entropy key using a second instance of the symmetric key.

### CROSS-REFERENCES TO RELATED APPLICATIONS

This application claims priority to U.S. Patent Application Ser. No. 63/595,876 (the “'876 Application”), filed Nov. 3, 2023, entitled, “Systems and Methods to Transfer Machine-Generated Secrets,” the disclosure of which is incorporated herein by reference in its entirety for all purposes.

### BACKGROUND

In some situations, transferring data, such as high entropy keys (e.g., machine-generated secrets), may be susceptible to interception of such data. It is with respect to this general technical environment to which aspects of the present disclosure are directed.

### BRIEF DESCRIPTION OF THE DRAWINGS

A further understanding of the nature and advantages of particular embodiments may be realized by reference to the remaining portions of the specification and the drawings, which are incorporated in and constitute a part of this disclosure.

FIG. 1 depicts an example system for implementing transfer of high entropy keys, in accordance with various embodiments.

FIG. 2 depicts an example sequence flow for implementing transfer of high entropy keys, in accordance with various embodiments.

FIG. 3 depicts another example sequence flow for implementing transfer of high entropy keys, in accordance with various embodiments.

FIG. 4A and 4B depict yet another example sequence flow for implementing transfer of high entropy keys, in accordance with various embodiments.

FIGS. 5A-5D depict various example systems for implementing transfer of high entropy keys, in accordance with various embodiments.

FIG. 6 depicts a flow diagram illustrating an example method for implementing transfer of high entropy keys, in accordance with various embodiments.

FIG. 7 depicts a flow diagram illustrating another example method for implementing transfer of high entropy keys, in accordance with various embodiments.

FIG. 8 depicts a flow diagram illustrating yet another example method for implementing transfer of high entropy keys, in accordance with various embodiments.

FIG. 9 depicts a block diagram illustrating an exemplary computer or system hardware architecture, in accordance with various embodiments.

### DETAILED DESCRIPTION OF CERTAIN EMBODIMENTS

### Overview

A zero-knowledge architecture is an architectural pattern in which a service provider stores and/or processes a customer's data while ensuring this data is never accessible by the service provider employees or by anyone having rogue access to their systems, and where such protection is ensured through architectural design and not only access control design. Zero-knowledge software (software that relies on a zero-knowledge architecture) may, however, require certain constraints for an authentication flow. These constraints may make it difficult to achieve what would ordinarily be simple for a non-zero-knowledge architecture. Account recovery, new sign-in to an existing account, and/or server-side data verification may be more complicated to achieve with a zero-knowledge architecture. Additional complications may be introduced when the knowledge factor is removed from the architecture. A knowledge-factor based password (e.g., a user-selected password) may be a good way to authenticate into a zero-knowledge architecture. However, such an approach may be vulnerable to phishing attacks, may be susceptible to the user forgetting the password, and may also be potentially more susceptible to brute force attempts, depending on the complexity of a user-selected password. Passwords are also generally lower in entropy than a machine generated key. If the password is replaced with a high entropy key (e.g., a machine-generated secret), which is stored in a zero-knowledge manner, these issues may be mitigated, but new issues may be created. For example, one new issue may include connecting the zero-knowledge based account to a new device. The high entropy key may need to be transferred from a device that is already in possession of this secret to the new device.

For example, in zero-knowledge architectures, one stipulation may include that the encryption keys safeguarding the data should never be accessible to the system operators. This foundation pivots on two distinct approaches to authentication mechanisms: knowledge-based and high entropy keys.

In the knowledge-based approach, individual users personally manage their encryption key. This may necessitate the transfer of the secret between devices by the users themselves to access encrypted data across multiple platforms. However, this process may introduce inconvenience as it may rely heavily on human memory and manual transfer. As an example, each customer of a password manager may have an encryption key, called a master password, that only the user knows. This master password may be used as an encryption key to encrypt vault data locally on their device. When registering a new device, the customer is requested to input that master password to decrypt their data.

Conversely, the high entropy key approach may eradicate the need for human memory in the management of secrets. Despite offering a higher degree of convenience, this approach may demand supplementary steps to employ the secret at different points of data access, as it may eliminate the human-knowledge factor traditionally used in authentication processes. Because there is no protocol allowing a simple and secure transfer of high entropy keys between two devices without a key transiting in clear in the service provider servers, and because this transit in clear is not acceptable when dealing with a zero-knowledge based account, connecting the zero-knowledge based account to a new device can be very inconvenient. For instance, transferring the high entropy key from one device to another could be achieved by asking the user to type a long one-time secret displayed on an existing device into a new device.

In examples, the present systems and methods may bridge the gap between security and convenience in the existing frameworks. The present systems and methods may harmonize security with usability, paving the way for a more resilient and user-friendly cryptographic architecture. In some examples, risks of using passwords may be mitigated when moving a system to a password-less system.

In examples, two main attacks need be considered, and the present systems and methods may protect against each of the following:
(1) A malicious user is attempting to trick the user into passing the high entropy key to the attacker's device;
(2) A malicious user is attempting to load their account onto the victim's device.

Those attacks can be achieved by attacking at different points of the system, specifically, but not limited to, some ways that an attacker could try to achieve the attacks described above, including:
Eavesdropping into the network exchanges that take place between devices, for example by having access to a password-manager's server or to part of the network that transmits data then the password manager's servers;
Being physically close to the user while during the device-to-device secret transfer, and as a result being able to see and use what is displayed on the user devices (e.g., QR codes, secrets, etc.);
Tricking the user into clicking on a link during the device-to-device secret transfer in order to have the user starting a device-to-device transfer on a phishing website.

In aspects of the present disclosure, a system is provided in which a secret can be transferred from one user device to another without the need for a knowledge-based secret.

In examples, a trusted device may generate a first key pair including a first ephemeral public key and a first ephemeral private key. In an example, a camera of the trusted device may capture a graphic code that is based on a second ephemeral public key and that is displayed by an untrusted device. The trusted device may extract the second ephemeral public key from the graphic code. The trusted device may generate a first instance of a symmetric key based on the first ephemeral private key and the second ephemeral public key; and the trusted device may encrypt a high entropy key with the first instance of the symmetric key. The trusted device may send the encrypted high entropy key and the first ephemeral public key to a server for transfer to the untrusted device. The encrypted high entropy key may be decryptable to obtain the high entropy key by using a second instance of the symmetric key that is generated by the untrusted device using the first ephemeral public key and a second ephemeral private key, where the second ephemeral private key and the second ephemeral public key may be generated by the untrusted device as a second key pair.

These and other aspects of the transfer of machine-generated secrets and/or high entropy keys are described in greater detail with respect to the figures.

The following detailed description illustrates a few exemplary embodiments in further detail to enable one of skill in the art to practice such embodiments. The described examples are provided for illustrative purposes and are not intended to limit the scope of the invention.

In the following description, for the purposes of explanation, numerous specific details are set forth in order to provide a thorough understanding of the described embodiments. It will be apparent to one skilled in the art, however, that other embodiments of the present invention may be practiced without some of these specific details. In other instances, certain structures and devices are shown in block diagram form. Several embodiments are described herein, and while various features are ascribed to different embodiments, it should be appreciated that the features described with respect to one embodiment may be incorporated with other embodiments as well. By the same token, however, no single feature or features of any described embodiment should be considered essential to every embodiment of the invention, as other embodiments of the invention may omit such features.

In an aspect, the technology relates to a method for transferring a high entropy key, including generating, by a trusted device, a first key pair including a first ephemeral public key and a first ephemeral private key. The method may further include capturing, by a camera of the trusted device, a graphic code that is based on a second ephemeral public key and that is displayed by an untrusted device; and extracting, by the trusted device, the second ephemeral public key from the graphic code. The method may further include generating, by the trusted device, a first instance of a symmetric key based on the first ephemeral private key and the second ephemeral public key; and encrypting, by the trusted device, a high entropy key with the first instance of the symmetric key. The method may further include sending, by the trusted device, the encrypted high entropy key and the first ephemeral public key to a server for transfer to the untrusted device.

In another aspect, the technology relates to a method, including generating, by a trusted device, a first key pair including a first ephemeral public key and a first ephemeral private key. The method may further include generating, by the trusted device, a graphic code that is based on a first ephemeral public key and a user identifier; and displaying, by the trusted device, the graphic code for capture by a camera of an untrusted device. The method may further include sending, by the trusted device and to a server, a request for a second ephemeral public key that is generated by the untrusted device; and receiving, by the trusted device and from the server, the second ephemeral public key. The method may further include receiving, by the trusted device and through a user interface, a user input including a first code; decoding, by the trusted device, the first code to obtain the second ephemeral public key; and performing a comparison. In examples, performing the comparison includes performing one of: a first comparison, by the trusted device, of the second ephemeral public key received from the server with the second ephemeral public key that is decoded from the first code; or a second comparison, by the trusted device, of the first code with a second code derived from the user identifier and the second ephemeral public key that is received from the server. The method may further include, after obtaining a match for one of the first comparison or the second comparison, generating, by the trusted device, a first instance of a symmetric key based on the first ephemeral private key and the second ephemeral public key; encrypting, by the trusted device, a high entropy key with the first instance of the symmetric key; and sending, by the trusted device, the encrypted high entropy key to the server for transfer to the untrusted device.

In yet another aspect, the technology relates to a server, including a processing system and memory coupled to the processing system. The memory may include computer executable instructions that, when executed by the processing system, causes the server to perform operations including receiving, from an untrusted device, a first request for a key exchange with the trusted device. The first request may include a transfer identifier (“ID”) and a cryptographic hash of a second ephemeral public key. The second ephemeral public key may be generated by the untrusted device as a second key pair with a second ephemeral private key. The operations may further include receiving, from the trusted device, a second request for a key exchange with the untrusted device; and, in response to receiving the second request, sending, to the trusted device, the transfer ID and the cryptographic hash of the second ephemeral public key. The operations may further include receiving, from the trusted device, a third request to send a first ephemeral public key to the untrusted device, the third request including the first ephemeral public key and the transfer ID; and in response to receiving the third request, sending, to the untrusted device, the first ephemeral public key. The operations may further include receiving, from the untrusted device, a fourth request to send a second ephemeral public key to the trusted device, the fourth request including the second ephemeral public key and the transfer ID; and, in response to receiving the fourth request, sending, to the trusted device, the second ephemeral public key. The operations may further include receiving, from the trusted device, an encrypted high entropy key that is encrypted by the trusted device using a first instance of a symmetric key; and sending, to the untrusted device, the encrypted high entropy key.

Various modifications and additions can be made to the embodiments discussed herein without departing from the scope of the invention. For example, while the embodiments described above refer to particular features, the scope of this invention also includes embodiments having different combinations of features and embodiments that do not include all of the above-described features.

### Specific Exemplary Embodiments

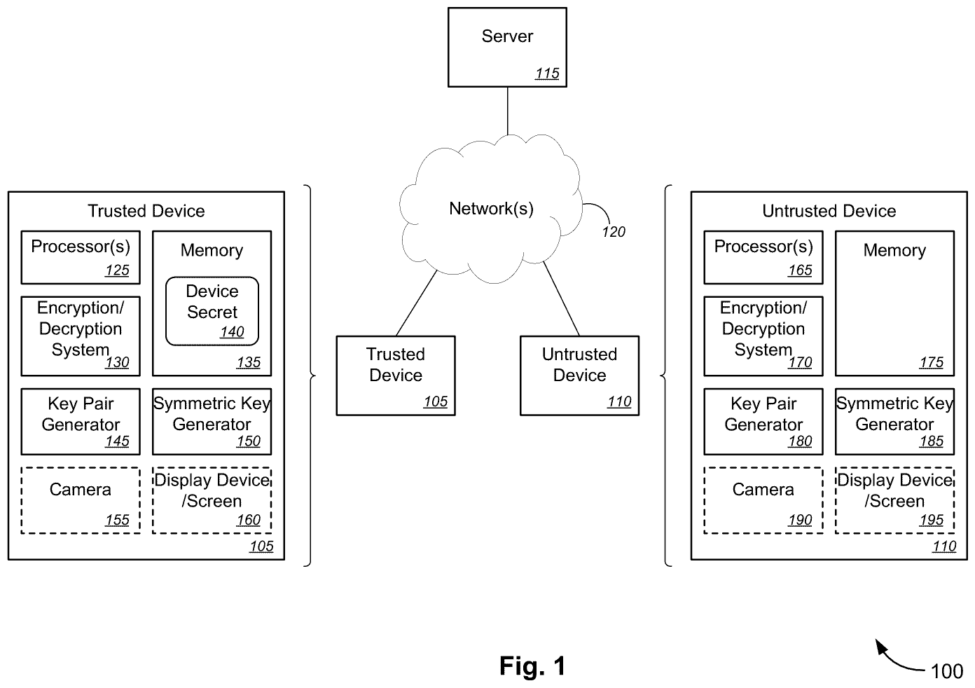

Turning to the embodiments as illustrated by the drawings, FIGS. 1-9 illustrate some of the features of methods, systems, and apparatuses for implementing data transfer, and, more particularly, to methods, systems, and apparatuses for implementing transfer of high entropy keys (e.g., machine-generated secrets), as referred to above. The methods, systems, and apparatuses illustrated by FIGS. 1-9 refer to examples of different embodiments that include various components and steps, which can be considered alternatives or which can be used in conjunction with one another in the various embodiments. The description of the illustrated methods, systems, and apparatuses shown in FIGS. 1-9 is provided for purposes of illustration and should not be considered to limit the scope of the different embodiments.

With reference to the figures, FIG. 1 depicts an example system 100 for implementing transfer of high entropy keys (e.g., machine-generated secrets), in accordance with various embodiments. In FIG. 1, system 100 may include trusted device 105, untrusted device 110, server 115, and network(s) 120. Trusted device 105 may include a processor(s) 125, an encryption and/or decryption system 130, and a memory 135. A device secret 140 (also referred to herein as “machine secret” or “machine-generated secret” or the like) may be stored in memory 135. Trusted device 105 may further include key pair generator 145 and symmetric key generator 150. In an example, trusted device 105 may further include camera 155, without display device or display screen 160. In another example, trusted device 105 may further include display device or display screen 160, without camera 155. In yet another example, trusted device 105 may further include both camera 155 and display device or display screen 160. In still another example, trusted device 105 lacks both camera 155 and display device or display screen 160.

Untrusted device 110 may include a processor(s) 165, an encryption and/or decryption system 170, and a memory 175. The device secret 140, after being transferred from the trusted device 105 (in some cases, via server 115), may be stored in memory 175. Untrusted device 110 may further include key pair generator 180 and symmetric key generator 185. In an example, untrusted device 110 may further include camera 190, without display device or display screen 195. In another example, untrusted device 110 may further include display device or display screen 195, without camera 190. In yet another example, untrusted device 110 may further include both camera 190 and display device or display screen 195. In still another example, untrusted device 110 lacks both camera 190 and display device or display screen 195.

In examples, the trusted device 105 may be a device that contains a high entropy key (e.g., machine secret or device secret 140, or the like). In some cases, trusted device 105 may include not only a device that has the capability of possessing the high entropy key, but also one on which a user has activated the high entropy key in order to be used. This could be based on the user unlocking a local device via a low entropy local knowledge factor or some biometric mechanism. In some instances, the trusted device 105 may include one of a desktop computer, a laptop computer, a tablet computer, a smart phone, a mobile phone, or other mobile device or other stationary device, or the like. In some examples, the untrusted device 110 may be a device that does not initially contain the high entropy key, or where the high entropy key may be initially unavailable (e.g., stored in an encrypted form) until activated by the user. In some cases, the untrusted device 110 may include one of a desktop computer, a laptop computer, a tablet computer, a smart phone, a mobile phone, or other mobile device or other stationary device, or the like. In examples, the server 115 may be a computing device (having memory and one or more processor(s)) that is operated by a service operator and that does not contain any unencrypted user data and that may be used to transfer information between devices.

In some instances, network(s) 120 may each include at least one of a distributed computing network, such as the Internet, a private network, a commercial network, or a cloud network, and/or the like.

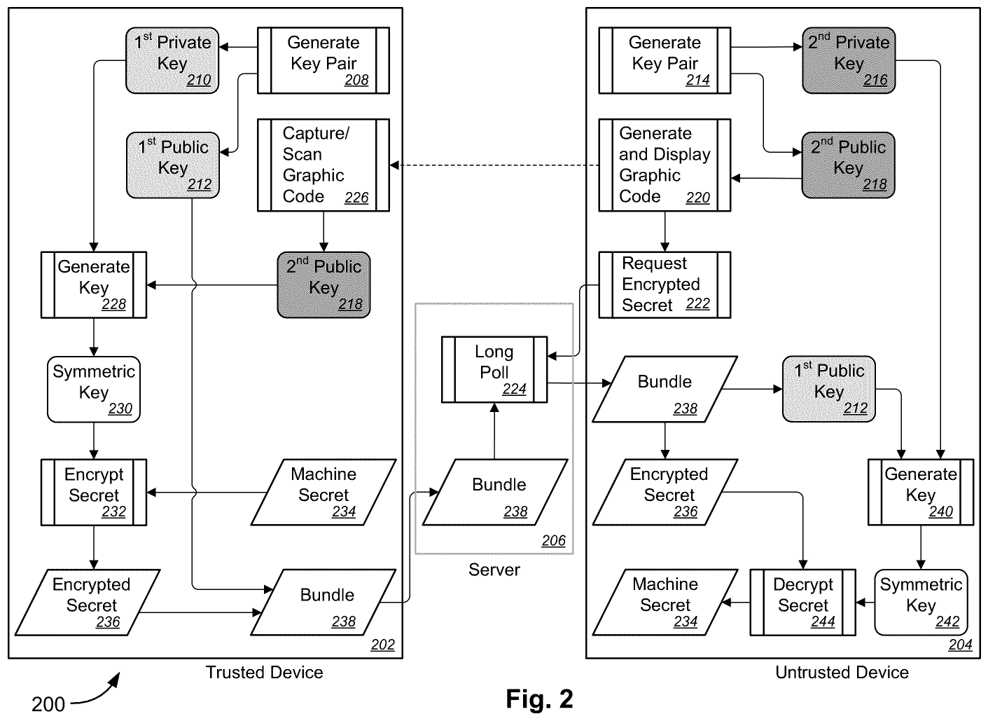

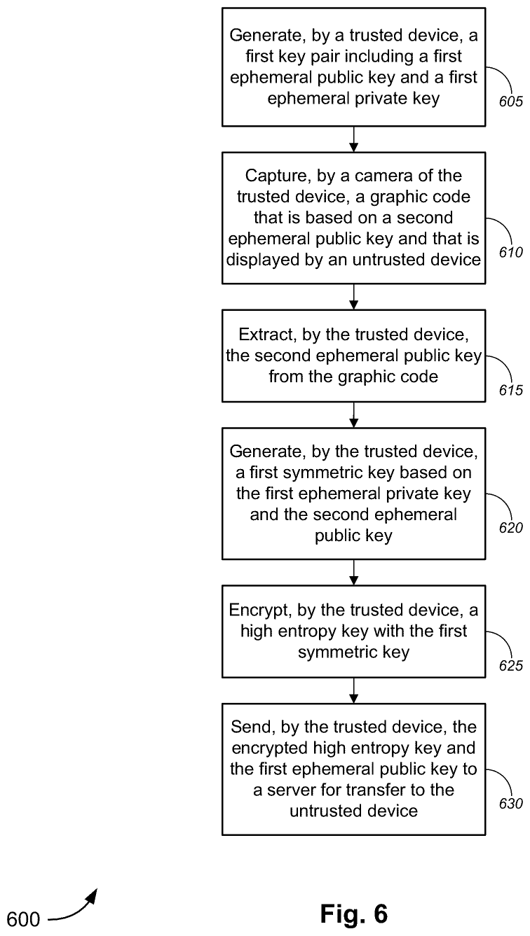

In operation, trusted device 105, untrusted device 110, and/or server 115 (collectively, “computing system”) may perform methods for implementing transfer of high entropy keys (e.g., machine-generated secrets), as described in detail with respect to FIGS. 2-8. For example, sequence flows 200-400 as described below with respect to FIGS. 2-4, respectively, and methods 600-800 as described below with respect to FIGS. 6-8 may be applied with respect to the operations of system 100 of FIG. 1.

FIG. 2 depicts an example sequence flow 200 for implementing transfer of high entropy keys (e.g., machine-generated secrets), in accordance with various embodiments. In some embodiments, trusted device 202, untrusted device 204, server 206, and machine secret 234 (e.g., high entropy key) of FIG. 2 may be similar, if not identical, to the trusted device 105, untrusted device 110, server 115, and device secret 140, respectively, of system 100 of FIG. 1, and the description of these components of system 100 of FIG. 1 are similarly applicable to the corresponding components of FIG. 2.

With reference to FIG. 2, trusted device 202 may generate a first key pair (at operation 208). The first key pair may include first private key 210 and first public key 212. The untrusted device 204 may generate a second key pair (at operation 214). The second key pair may include second private key 216 and second public key 218. At operation 220, untrusted device 204 may generate and display a graphic code that is based on the second public key 218. In some cases, generating the graphic code includes encoding the second public key 218 into the graphic code. In examples, the graphic code may include one of a linear barcode or a quick response (“QR”) code. In some examples, the graphic code may be displayed on a display screen (e.g., display device or display screen 195 of FIG. 1, or the like). In some cases, the display screen may be either integrated with the untrusted device 204 or external, yet communicatively coupled, to the untrusted device 204. At operation 222, untrusted device 204 may request an encrypted secret, in some cases, by using a long-poll-based, substantially real-time communication between the untrusted device 204 and the server 206. At operation 224, the server 206, in response to or after receiving the request (at operation 222), may initiate a long poll for the encrypted secret from the trusted device 202.

At operation 226, trusted device 202 may capture or scan the graphic code that is displayed by the untrusted device 204, in some cases, using a camera (e.g., camera 155 of FIG. 1, or the like) of the trusted device 202. In examples, operation 226 may be performed at the direction of a user of the trusted device 202 and the untrusted device 204. At operation 228, the trusted device 202 may generate a first instance of a symmetric key 230, using the first private key 210 of the trusted device 202 and the second public key 218 of the untrusted device 204, the second public key 218 being extracted from the captured graphic code. At operation 232, trusted device 202 may use the first instance of the symmetric key 230 to encrypt a machine secret 234 as encrypted secret 236, in some cases, using an encryption system (e.g., encryption and/or decryption system 130 of FIG. 1, or the like). The encrypted secret 236 and the first public key 212 may be bundled as bundle 238. The bundle 238 may be transferred to the untrusted device 204 via server 206, in some cases, in response to the long poll (which may be initiated at operation 224). After transferring to the untrusted device 204, the encrypted secret 236 and the first public key 212 may be extracted from the bundle 238. In some examples, the bundle 238 may further include an email address of the user, and, after transfer to the untrusted device 204, the email address may be extracted from the bundle 238. The email address may be displayed by the untrusted device 204 as a visual check for the user to verify that the user's account (rather than someone else's account) is being loaded. Because there is a possibility that an attacker could scan the graphic code (e.g., a QR code, etc.) before the user does, which would result in the untrusted device loading the attacker's account and not the user's account, such email verification provides the user with confidence that their account is being loaded and not someone else's account.

At operation 240, untrusted device 204 may generate a second instance of the symmetric key 242 using the first public key 212 and the second private key 216. The second instance of the symmetric key 242 corresponds to the first instance of the symmetric key 230, and by definition should be identical. In examples, each of the first instance of the symmetric key 230 and the second instance of the symmetric key 242 may be generated using one of a Diffie-Hellman key exchange algorithm, an elliptic-curve Diffie-Hellman (“ECDH”) key agreement algorithm, an authenticated key exchange (“AKE”) algorithm, or another key-agreement algorithm, and/or the like. At operation 244, untrusted device 204 may use the system instance of the symmetric key 242 to decrypt the encrypted secret 236 to obtain the machine secret 234. In some instances, the encrypted secret 236 may be decrypted by the untrusted device 204 using a decryption system (e.g., encryption and/or decryption system 170 of FIG. 1, or the like). The machine secret 234 may then be available for use by the untrusted device 204 (e.g., to decrypt protected data, such as by a password manager application installed on the untrusted device 204, and/or the like).

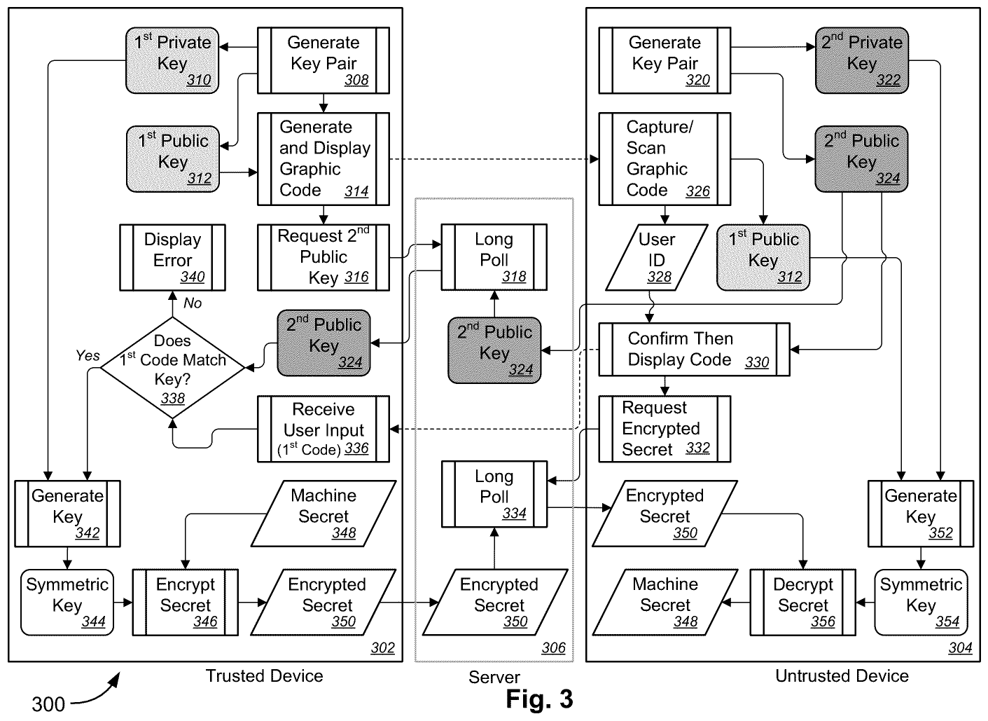

FIG. 3 depicts another example sequence flow 300 for implementing transfer of high entropy keys (e.g., machine-generated secrets), in accordance with various embodiments. In some embodiments, trusted device 302, untrusted device 304, server 306, and machine secret 348 (e.g., high entropy key) of FIG. 3 may be similar, if not identical, to the trusted device 105, untrusted device 110, server 115, and device secret 140, respectively, of system 100 of FIG. 1, and the description of these components of system 100 of FIG. 1 are similarly applicable to the corresponding components of FIG. 3.

Referring to FIG. 3, trusted device 302 may generate a first key pair (at operation 308). The first key pair may include first private key 310 and first public key 312. At operation 314, trusted device 302 may generate and display a graphic code that is based on the first public key 312 and user ID associated with a user of the trusted device 302. In some cases, generating the graphic code includes encoding the first public key 312 into the graphic code. In examples, the graphic code may include one of a linear barcode or a QR code. In some examples, the graphic code may be displayed on a display screen (e.g., display device or display screen 155 of FIG. 1, or the like). In some cases, the display screen may be either integrated with the trusted device 302 or external, yet communicatively coupled, to the trusted device 302. At operation 316, trusted device 302 may request a second public key from the untrusted device 304, in some cases, by using a long poll-based real-time communication between the trusted device 302 and the server 306. At operation 318, the server 306, in response to or after receiving the request (at operation 316), may include initiating a long poll for the second public key from the untrusted device 304.

The untrusted device 304 may generate a second key pair (at operation 320). The second key pair may include second private key 322 and second public key 324. At operation 326, untrusted device 304 may capture or scan the graphic code that is displayed by the trusted device 302, in some cases, using a camera (e.g., camera 190 of FIG. 1, or the like) of the untrusted device 304. The first public key 312 and user ID 328 may be extracted from the graphic code. At operation 330, untrusted device 304 may confirm the user ID 328, and, if confirmed, may display a first code that is based on the user ID 328 and the second public key 324. In some examples, the first code may be displayed on a display screen (e.g., display device or display screen 195 of FIG. 1, or the like). In some cases, the display screen may be either integrated with the untrusted device 304 or external, yet communicatively coupled, to the untrusted device 304. At operation 332, untrusted device 304 may request an encrypted secret, in some cases, by using a long-poll-based, substantially real-time communication between the untrusted device 304 and the server 306. At operation 334, the server 306, in response to or after receiving the request (at operation 332), may include initiating a long poll for the encrypted secret from the trusted device 302.

At operation 336, trusted device 302 may receive, through a user interface, a user input from the user, the user input may include a second code. For example, the user of the trusted device may read the displayed first code on the untrusted device and enter it through a user interface on the trusted device 302. If the procedure is correctly performed, the entered second code will correspond to the first code. In examples, each of the first and second code is one of a word, an alphanumeric code, a random code, or a personal identification number (“PIN”) code, and/or the like. In examples, the alphanumeric code may include a multiple-digit code (e.g., a 6-digit code, or the like). At operation 338, the trusted device 302 may perform a comparison. In an example, the trusted device 302 may decode the second code to obtain the second public key 324, and the comparison (at operation 338) may include comparing the second public key 324 received from the server 306 via long poll 318 with the second public key that is decoded from the second code. Alternatively, in another example, the trusted device 302 may generate a third code based on the user ID 328 and the second public key 324 received from the server 306 via long poll 318, and the comparison (at operation 338) may include comparing the second code with the third code. Based on a determination that there is no match based on the comparison (at operation 338), trusted device 302 may display an error (at operation 340). Based on a determination that there is a match (i.e., after obtaining a match for the comparison), at operation 342, the trusted device 302 may generate a first instance of a symmetric key 344, using the first private key 310 of the trusted device 302 and the second public key 324 of the untrusted device 304.

At operation 346, trusted device 302 may use the first instance of the symmetric key 344 to encrypt a machine secret 348 as encrypted secret 350, in some cases, an encryption system (e.g., encryption and/or decryption system 130 of FIG. 1, or the like). The encrypted secret 350 may be transferred to the untrusted device 304 via server 306, in some cases, in response to the long poll (which may be initiated at operation 334). After transferring to the untrusted device 304, at operation 352, untrusted device 304 may generate a second instance of the symmetric key 354 using the first public key 312 that is obtained from the captured graphic code (at operation 326) and the second private key 322. The second instance of the symmetric key 354 corresponds to the first instance of the symmetric key 344, and by definition should be identical. In examples, each of the first instance of the symmetric key 344 and the second instance of the symmetric key 354 may be generated using one of a Diffie-Hellman key exchange algorithm, an ECDH key agreement algorithm, an AKE algorithm, or another key-agreement algorithm, and/or the like. At operation 356, untrusted device 304 may use the second instance of the symmetric key 354 to decrypt the encrypted secret 350 to obtain the machine secret 348. In some instances, the encrypted machine secret may be decrypted by the untrusted device using a decryption system (e.g., encryption and/or decryption system 170 of FIG. 1, or the like). The machine secret 348 may then be available for use by the untrusted device 304 (e.g., to decrypt protected data, such as by a password manager application installed on the untrusted device 304, and/or the like).

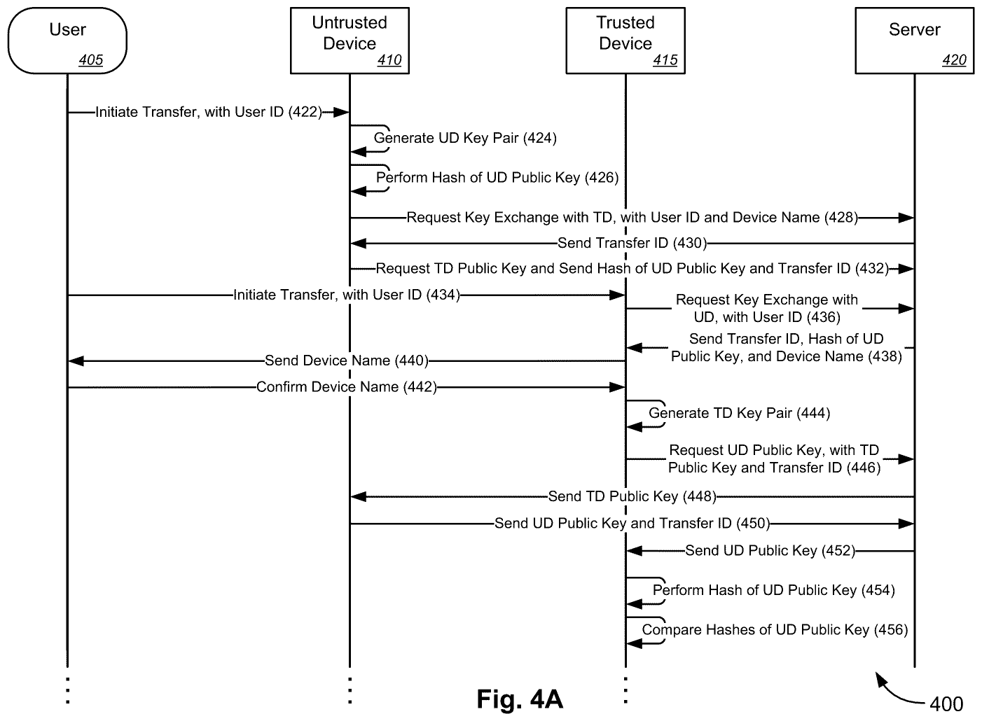

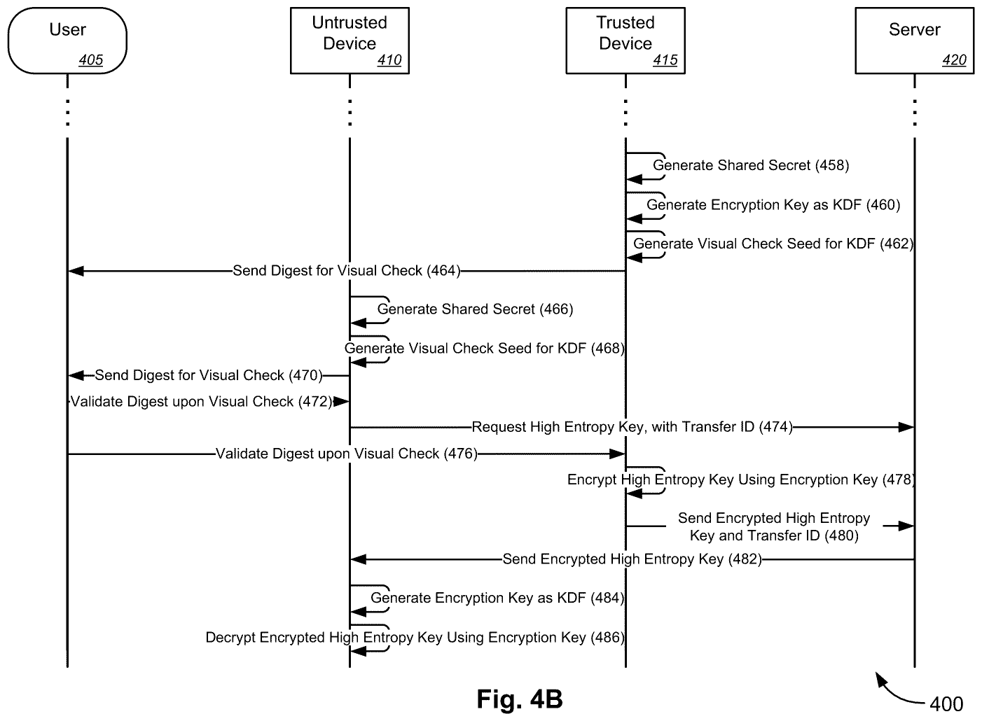

FIG. 4A and 4B (collectively, “Fig. 4”) depict yet another example sequence flow 400 for implementing transfer of high entropy keys (e.g., machine-generated secrets), in accordance with various embodiments. In some examples, example sequence flow 400 may be used when there is no camera on any of the devices between which the high entropy keys are transferred (e.g., the trusted device and the untrusted device). In other examples, example sequence flow 400 may be used even when at least one of the devices between which the high entropy keys are transferred (e.g., the trusted device and the untrusted device) has a camera. In some embodiments, untrusted device 410, trusted device 415, and server 420 of FIG. 4 may be similar, if not identical, to the untrusted device 110, trusted device 105, and server 115, respectively, of system 100 of FIG. 1, and the description of these components of system 100 of FIG. 1 are similarly applicable to the corresponding components of FIG. 4.

With reference to FIG. 4A, user 405 may initiate transfer of a high entropy key at untrusted device 410 (at operation 422), in some cases, including a user ID associated with the user 405. The untrusted device 410 may generate an untrusted device (“UD”) key pair (at operation 424). The UD key pair may include a UD private key (similar to second private key 216 or 322 of FIG. 2 or 3, or the like) and a UD public key (similar to second public key 218 or 324 of FIG. 2 or 3, or the like). At operation 426, the untrusted device 410 may perform a hash of the UD public key, in some cases, using a cryptographic hash function. In some cases, the cryptographic hash function may include a secure hash algorithm (“SHA”). The untrusted device 410 may send, to server 420, a request for a key exchange with the trusted device 415 (at operation 428). The request may include the user ID and a device name of the untrusted device 410. In response to or after receiving the request, server 420 may send a transfer ID (at operation 430). At operation 432, the untrusted device 410 may send a request for a trusted device (“TD”) public key and may send the hash of the UD public key and the transfer ID.

At operation 434, the user may initiate transfer of a high entropy key at trusted device 415, in some cases, including a user ID associated with the user 405. The trusted device 415 may send, to server 420, a request for a key exchange with the untrusted device 410 (at operation 436). The request may include the user ID. In response to or after receiving the request, server 420 may send the transfer ID, the hash of the UD public key, and the device name of the untrusted device 410 (at operation 438). In response to or after receiving the transfer ID, the hash of the UD public key, and the device name, the trusted device 415 may send (or display) the device name to the user 405. At operation 442, the user 405 may confirm the device name. In response to or after receiving confirmation of the device name from the user 405, the trusted device 415 may generate a TD key pair (at operation 444). At operation 446, trusted device 415 may send a request for a UD public key. The request may include the TD public key and the transfer ID.

In response to or after receiving the request from the trusted device 415, server 420 may send the TD public key to the untrusted device 410 (at operation 448). In response to or after receiving the TD public key, the untrusted device 410 may send the UD public key and the transfer ID (at operation 450). In response to or after receiving the UD public key from the untrusted device 410, the server 420 may send the UD public key to the trusted device 415 (at operation 452). In response to or after receiving the UD public key from the server, the trusted device 415 may perform a hash of the UD public key (at operation 454). At operation 456, the trusted device 415 may compare the hash of the UD public key as received from the untrusted device 410 via the server 420 with the hash of the UD public key as obtained at operation 454. The sequence flow 400 continues in FIG. 4B.

Turning to FIG. 4B, the trusted device 415 may generate a shared secret (at operation 458). In some cases, the shared secret may include a symmetric key that may be generated based on the UD public key and the TD private key. At operation 460, the trusted device 415 may generate an encryption key as a key derivation function (“KDF”). A KDF, as used herein, may refer to a cryptographic algorithm that derives one or more secret keys from a secret value such as a master key, a password, or passphrase. In this case, the KDF is used to derive the encryption key from at least one of the shared secret, the UD public key, and/or the TD public key. At operation 462, the trusted device 415 may generate a visual check seeded by a KDF upon the shared secret, the UD public key, and/or the TD public key. The trusted device 415 may send a digest for visual check (at operation 464). As used herein, the digest may refer to a cryptographic hash function containing a string of digits created by a one-way hashing function (in this case, a string of digits created by hashing of the visual check seed for the KDF).

In addition, the untrusted device 410 may similarly generate a shared secret (at operation 466). In some cases, the shared secret may include a symmetric key that may be generated based on the TD public key and the UD private key. At operation 468, the untrusted device 410 may generate a visual check seeded by a KDF upon the shared secret, the UD public key, and/or the TD public key. At operation 470, the untrusted device 410 may send a digest of the visual check seed generated at operation 468. At operation 472, the user may validate, upon visual check, the digest as sent from the untrusted device 410. After the digest has been validated by the user 405, the untrusted device 410 may send, to the server 420, a request for a high entropy key (at operation 474). The request may include the transfer ID. At operation 476, the user may validate, upon visual check, the digest as sent from the trusted device 415. After the digest has been validated by the user 405, the trusted device 415 may encrypt the high entropy key using the encryption key (at operation 478), and may send, to the server 420, the encrypted high entropy key and the transfer ID (at operation 480). At operation 482, the server 420 may send, to the untrusted device 410, the encrypted high entropy key. At operation 484, the untrusted device 410 may generate an encryption key as KDF. In this case, the KDF is used to derive the encryption key from at least one of the shared secrets, the UD public key, and/or the TD public key. At operation 486, the untrusted device 410 may decrypt the encrypted high entropy key using the encryption key generated at operation 484.

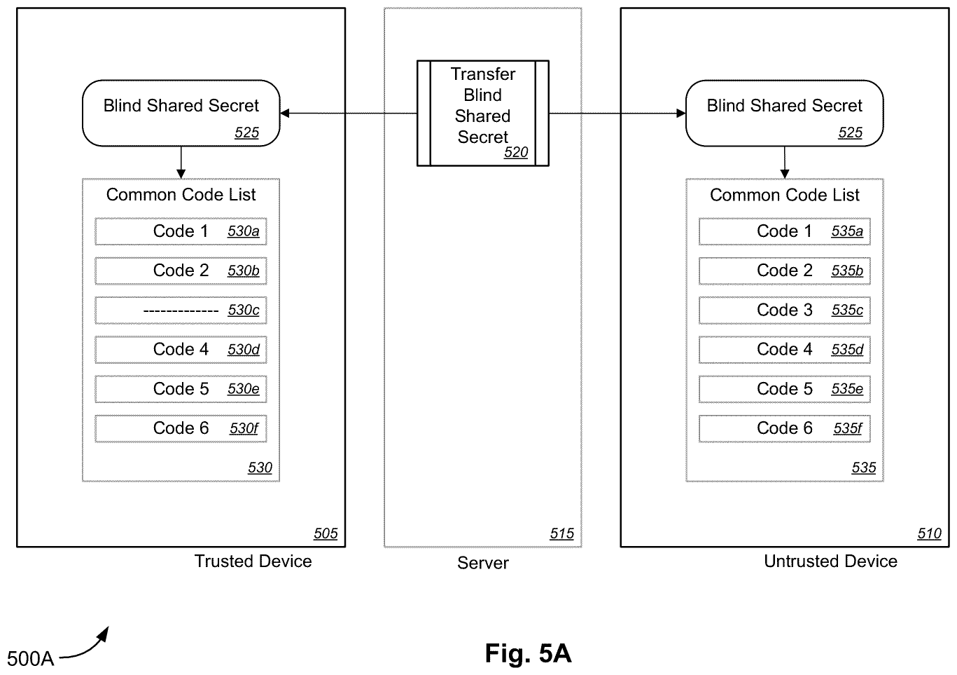

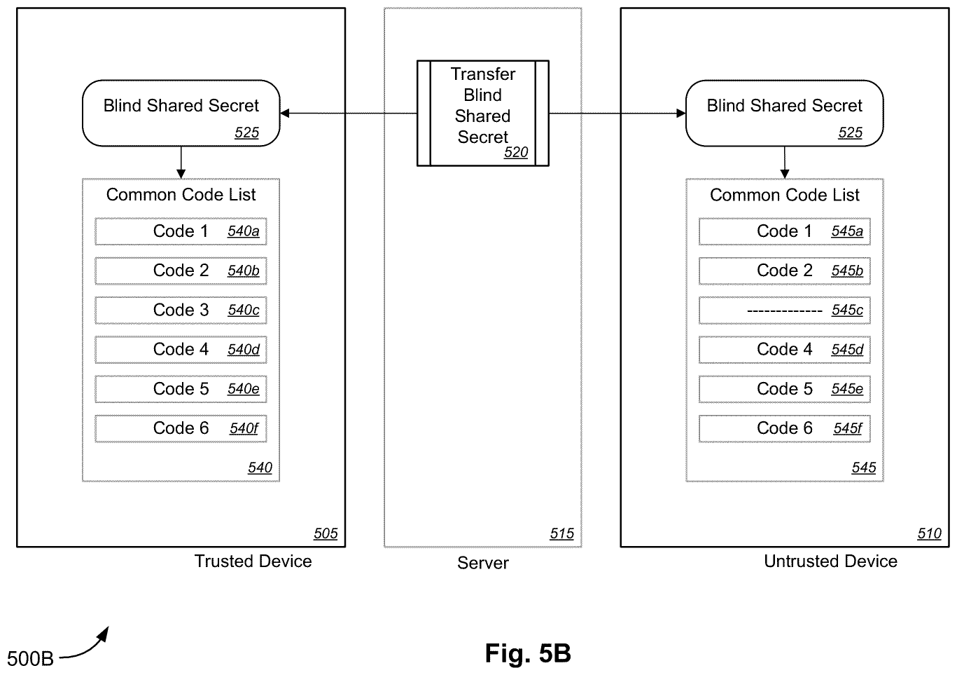

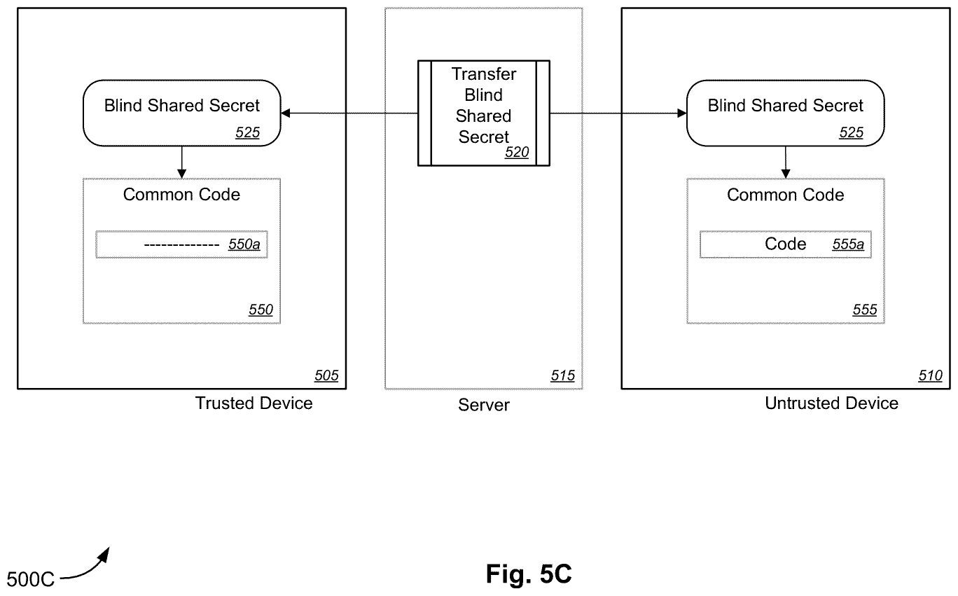

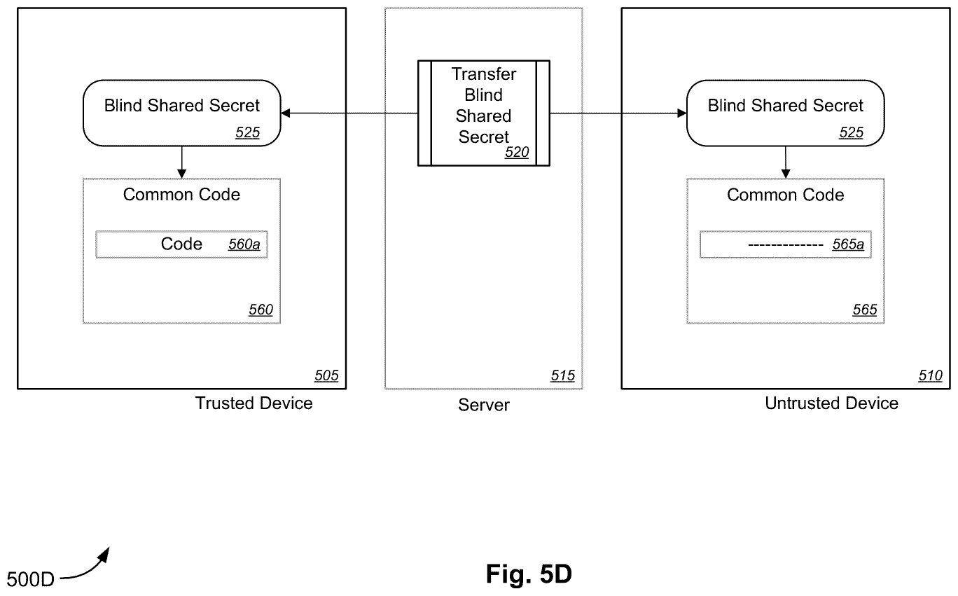

FIGS. 5A-5D (collectively, “FIG. 5”) depict various example systems 500A-500D for implementing transfer of high entropy keys (e.g., machine-generated secrets), in accordance with various embodiments. In some examples, there is no camera on any of the devices between which the high entropy keys are transferred (e.g., the trusted device and the untrusted device). In other examples, at least one of the devices between which the high entropy keys are transferred (e.g., the trusted device and the untrusted device) has a camera. In some embodiments, trusted device 505, untrusted device 510, and server 515 of FIG. 2 may be similar, if not identical, to the trusted device 105, untrusted device 110, and server 115, respectively, of system 100 of FIG. 1, and the description of these components of system 100 of FIG. 1 are similarly applicable to the corresponding components of FIG. 2.

In some aspects, an active adversary in the middle (“AITM”) or man in the middle (“MITM”) attack or security model may include that a malicious actor can replace genuine public keys with their own, allowing the malicious actor to decrypt the high entropy key once it is sent from the trusted device. In order to counter this threat, the shared secret may be validated through some derived information. In one set of examples, such as shown in FIGS. 5A and 5B, a number of words (e.g., six) may be selected from a dictionary (e.g., of around 7000 words) based on the deriving information of the shared secret. It is highly unlikely that different public keys would lead to the same set of six words. In this example, the trusted device only displays five of the words and the untrusted device displays all six words, and the user must now input the missing word into the trusted device. In this example, the user is in possession of both the trusted and untrusted devices, and the user will initiate the transfer flow. The transfer flow will not continue if the public key has been intercepted at the server, as the chance of matching the missing word based on a different public key is very low.

In alternative aspects, the high entropy key transfer may be facilitated by a temporary knowledge secret. In this case, the trusted device may encrypt the high entropy key with a key based on a random password that would be displayed to the user. The user then can input the temporary password into the untrusted device, which may maintain zero-knowledge.

As shown in FIGS. 5A-5D, at operation 520, server 515 may transfer a blind shared secret 525, or the information to generate one, to both trusted device 505 and untrusted device 510. With a blind shared secret 525, server 515 is unable to read the shared secret, thus facilitating secure transfer of the shared secret. Turning to the non-limiting embodiment 500A of FIG. 5A, based on the blind shared secret 525, a common code list 530 may be displayed by the trusted device 505, using a display device (e.g., display device or display screen 160 of FIG. 1, or the like), while a common code list 535 may be displayed by the untrusted device 510. In some examples, one or more common codes among a plurality of common codes may be derived from the blind shared secret 525. In examples, the common code list 530 may include code 1 530a, code 2 530b, code 4 530d, code 5 530e, and code 6 530f, while the common code list 535 may include code 1 535a, code 2 535b, code 3 535c, code 4 535d, code 5 535e, and code 6 535f. In some cases, code 1 530a is the same as code 1 535a, while code 2 530b is the same as code 2 535b, and code 4 530d is the same as code 4 535d, while code 5 530e is the same as code 5 535e, and code 6 530f is the same as code 6 535f. As shown in FIG. 5A, the trusted device 505 may display a prompt to a user (e.g., blank space 530c, or the like) to input at least one common code that is displayed on the untrusted device 510 (in this case, code 3 535c, or the like).

Alternatively, referring to the non-limiting embodiment 500B of FIG. 5B, based on the blind shared secret 525, a common code list 540 may be displayed by the trusted device 505, using a display device (e.g., display device or display screen 160 of FIG. 1, or the like), while a common code list 545 may be displayed by the untrusted device 510. In some examples, the blind shared secret 525 may include one or more common codes among a plurality of common codes. In examples, the common code list 540 may include code 1 540a, code 2 540b, code 3 540c, code 4 540d, code 5 540e, and code 6 540f, while the common code list 545 may include code 1 545a, code 2 545b, code 4 545d, code 5 545e, and code 6 545f. In some cases, code 1 540a is the same as code 1 545a, while code 2 540b is the same as code 2 545b, and code 4 540d is the same as code 4 545d, while code 5 540e is the same as code 5 545e, and code 6 540f is the same as code 6 545f. As shown in FIG. 5B, the untrusted device 510 may display a prompt to a user (e.g., blank space 545c, or the like) to input at least one common code that is displayed on the trusted device 505 (in this case, code 3 540c, or the like).

Alternatively, with reference to the non-limiting embodiment 500C of FIG. 5C, based on the blind shared secret 525, a common code portion 550 may be displayed by the trusted device 505, using a display device (e.g., display device or display screen 160 of FIG. 1, or the like), while a common code portion 555 may be displayed by the untrusted device 510. In some examples, the blind shared secret 525 may include one or more common codes among a plurality of common codes. In examples, the common code portion 555 may include code 555a. As shown in FIG. 5C, the trusted device 505 may display a prompt to a user (e.g., blank space 550a, or the like) to input at least one common code that is displayed on the untrusted device 510 (in this case, code 555a, or the like).

Alternatively, turning to the non-limiting embodiment 500D of FIG. 5D, based on the blind shared secret 525, a common code portion 560 may be displayed by the trusted device 505, using a display device (e.g., display device or display screen 160 of FIG. 1, or the like), while a common code portion 565 may be displayed by the untrusted device 510. In some examples, the blind shared secret 525 may include one or more common codes among a plurality of common codes. In examples, the common code portion 560 may include code 560a. As shown in FIG. 5D, the untrusted device 510 may display a prompt to a user (e.g., blank space 565a, or the like) to input at least one common code that is displayed on the trusted device 505 (in this case, code 560a, or the like).

With respect to each of embodiments 500A-500D of FIGS. 5A-5D, in some instances, the plurality of common codes may include at least one of words, alphanumeric codes, or random codes, and/or the like. Also, with respect to each of embodiments 500A-500D of FIGS. 5A-5D, verification is confirmed if the code that is entered (e.g., via a user interface) matches the displayed at least one code. After the public keys have been validated, the high entropy key transfer can take place via the server with no further validation required. In examples, transfer of high entropy keys may proceed in accordance with one of sequence flows 200, 300, or 400 of FIG. 2, 3, or 4, respectively.

FIG. 6 depicts a flow diagram illustrating an example method 600 for implementing transfer of high entropy keys (e.g., machine-generated secrets), in accordance with various embodiments. In examples, FIG. 6 may correspond to system 100 of FIG. 1 and/or the sequence flow 200 of FIG. 2, taken from the perspective of the trusted device 105 and/or 202.

With reference to FIG. 6, method 600 may include, at operation 605, generating, by a trusted device (e.g., trusted device 105, 202, 302, 415, or 505 of FIGS. 1-5, or the like), a first key pair including a first ephemeral public key (e.g., first public key 212 of FIG. 2, or the like) and a first ephemeral private key (e.g., first private key 210 of FIG. 2, or the like), e.g., using a key pair generator (e.g., key pair generator 145 of FIG. 1, or the like). At operation 610, a camera (e.g., camera 155 of FIG. 1, or the like) of the trusted device may capture a graphic code that is based on a second ephemeral public key (e.g., second public key 218 of FIG. 2, or the like) and that is displayed by an untrusted device (e.g., untrusted device 110, 204, 304, 410, or 510 of FIGS. 1-5, or the like). The trusted device may extract the second ephemeral public key from the graphic code (at operation 615). In some examples, the graphic code may include one of a linear barcode or a QR code, or the like. In examples, the graphic code may be displayed on a display screen (e.g., display device or display screen 195 of FIG. 1, or the like), which may be either integrated with the untrusted device or external, yet communicatively coupled, to the untrusted device.

In examples, before an account is loaded on the untrusted device, a user identifier (e.g., an email address or another identifier of the user, or the like) may be displayed as a visual check for the user to be confident it is their account that is being loaded and not someone else's. In some examples, a user confirmation of the displayed identifier may be required before proceeding further. Otherwise, there is a possibility that an attacker could scan the graphic code before the user does, which may result in the untrusted device being loaded with the attacker's account and not with the account of the user.

The method 600 may further include, at operation 620, generating, by the trusted device, a first instance of a symmetric key (e.g., symmetric key 230 of FIG. 2, or the like) based on the first ephemeral private key and the second ephemeral public key, e.g., using a symmetric key generator (e.g., symmetric key generator 150 of FIG. 1, or the like). At operation 625, the trusted device may encrypt a high entropy key (e.g., device secret 140 of FIG. 1 or machine secret 234 of FIG. 2, or the like) with the first instance of the symmetric key, in some cases, using an encryption system (e.g., encryption and/or decryption system 130 of FIG. 1, or the like). The trusted device may send the encrypted high entropy key and the first ephemeral public key to a server (e.g., server 115, 206, 306, 420, or 515 of FIGS. 1-5, or the like) for transfer to the untrusted device (at operation 630).

In examples, the encrypted high entropy key may be decryptable to obtain the high entropy key by using a second instance of the symmetric key (e.g., symmetric key 242 of FIG. 2, or the like) that may be generated by the untrusted device using the first ephemeral public key and a second ephemeral private key (e.g., second private key 216 of FIG. 2, or the like). In some instances, the encrypted high entropy key may be decrypted by the untrusted device using a decryption system (e.g., encryption and/or decryption system 170 of FIG. 1, or the like). In some cases, the second ephemeral private key and the second ephemeral public key may be generated by the untrusted device as a second key pair. In some examples, each of the first instance of the symmetric key and the second instance of the symmetric key may be generated using one of a Diffie-Hellman key exchange algorithm, an ECDH key agreement algorithm, an AKE algorithm, or another key-agreement algorithm, and/or the like.

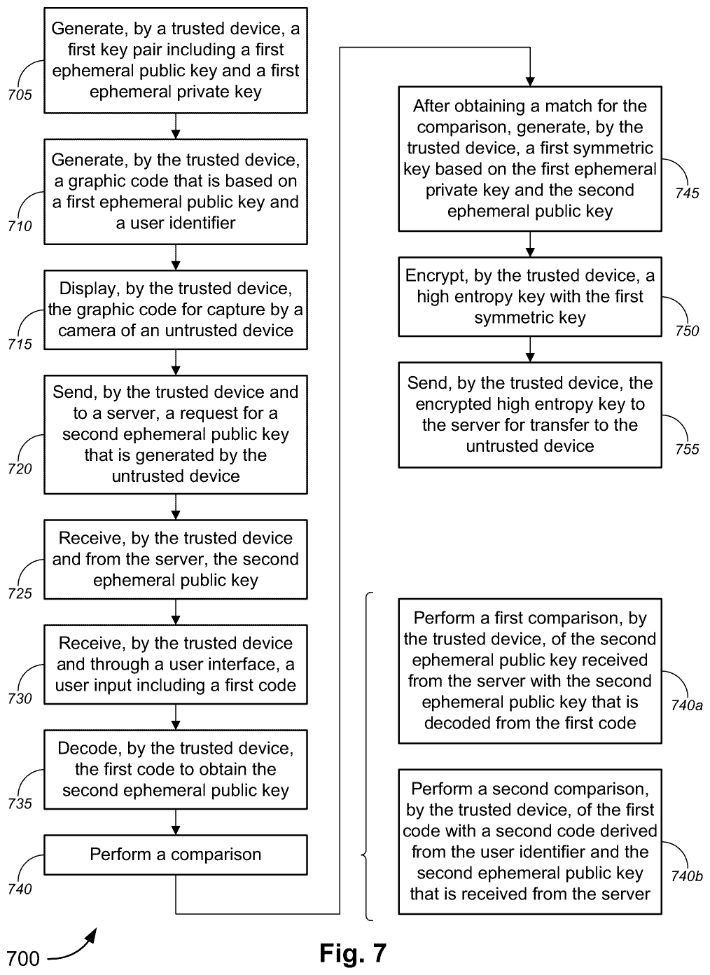

FIG. 7 depicts a flow diagram illustrating another example method 700 for implementing transfer of high entropy keys (e.g., machine-generated secrets), in accordance with various embodiments. In examples, FIG. 7 may correspond to system 100 of FIG. 1 and/or the sequence flow 300 of FIG. 3, taken from the perspective of the trusted device 105 and/or 302.

Referring to FIG. 7, method 700, at operation 705, may include generating, by a trusted device (e.g., trusted device 105, 202, 302, 415, or 505 of FIGS. 1-5, or the like), a first key pair including a first ephemeral public key (e.g., first public key 312 of FIG. 3, or the like) and a first ephemeral private key (e.g., first private key 310 of FIG. 3, or the like). At operation 710, the trusted device may generate a graphic code that is based on the first ephemeral public key and a user identifier, and may display the graphic code for capture by a camera (e.g., camera 190 of FIG. 1, or the like) of an untrusted device (e.g., untrusted device 110, 204, 304, 410, or 510 of FIGS. 1-5, or the like) (at operation 715). In some instances, the user identifier includes a user email or user identification information, wherein the graphic code includes one of a linear barcode or a QR code. The method may further include sending, by the trusted device and to a server (e.g., server 115, 206, 306, 420, or 515 of FIGS. 1-5, or the like), a request for a second ephemeral public key (e.g., second public key 324 of FIG. 3, or the like) that is generated by the untrusted device (at operation 720); and receiving, by the trusted device and from the server, the second ephemeral public key (at operation 725). In some cases, sending the request for the second ephemeral public key (at operation 720) may include requesting the second ephemeral public key using a long polling-based real-time communication between the trusted device and the server.

At operation 730, the trusted device may receive, through a user interface, a user input including a first code. In some instances, the first code may correspond to a second code that is generated by the untrusted device based on the user identifier and the second ephemeral public key and that may be displayed by the untrusted device. In some cases, the second code is one of a word, an alphanumeric code, or a random code, and/or the like. In examples, the alphanumeric code may include a multiple-digit code (e.g., a 6-digit code, or the like, but not limited to the number of digits). The trusted device may decode the first code to obtain the second ephemeral public key (at operation 735). At operation 740, method 700 may include performing a comparison. In examples, performing the comparison (at operation 740) may include performing one of: performing a first comparison, by the trusted device, of the second ephemeral public key received from the server with the second ephemeral public key that is decoded from the first code (at operation 740a); or performing a second comparison, by the trusted device, of the first code with a second code derived from the user identifier and the second ephemeral public key that is received from the server (at operation 740b). At operation 745, after obtaining a match for the comparison, the trusted device may generate a first instance of a symmetric key (e.g., symmetric key 344 of FIG. 3, or the like) based on the first ephemeral private key and the second ephemeral public key. The trusted device may encrypt a high entropy key (e.g., device secret 140 of FIG. 1 or machine secret 348 of FIG. 3, or the like) with the first instance of the symmetric key (at operation 750), and may send the encrypted high entropy key to the server for transfer to the untrusted device (at operation 755). In some instances, the high entropy key may be encrypted by the trusted device using an encryption system (e.g., encryption and/or decryption system 130 of FIG. 1, or the like).

In examples, the encrypted high entropy key may be decryptable to obtain the high entropy key by using a second instance of the symmetric key (e.g., symmetric key 354 of FIG. 3, or the like) that may be generated by the untrusted device using the first ephemeral public key and a second ephemeral private key (e.g., second private key 322 of FIG. 3, or the like). In some instances, the encrypted high entropy key may be decrypted by the untrusted device using a decryption system (e.g., encryption and/or decryption system 170 of FIG. 1, or the like). In some cases, the second ephemeral private key and the second ephemeral public key may be generated by the untrusted device as a second key pair. In some examples, each of the first instance of the symmetric key and the second instance of the symmetric key may be generated using one of a Diffie-Hellman key exchange algorithm, an ECDH key agreement algorithm, an AKE algorithm, or another key-agreement algorithm, and/or the like.

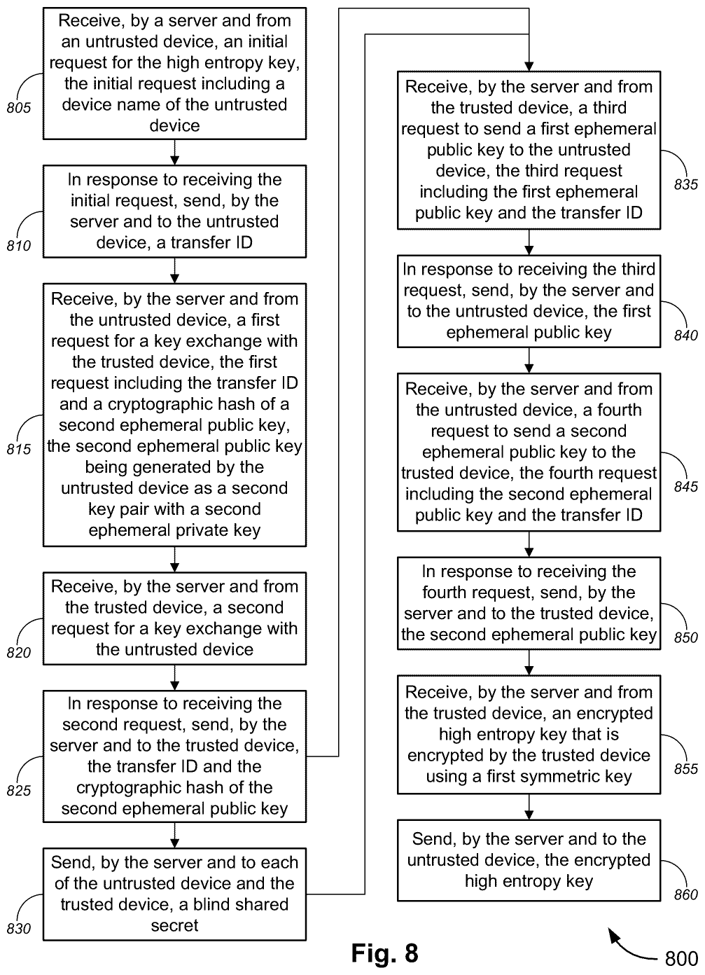

FIG. 8 depicts a flow diagram illustrating yet another example method 800 for implementing transfer of high entropy keys (e.g., machine-generated secrets), in accordance with various embodiments. In examples, FIG. 8 may correspond to system 100 of FIG. 1 and/or the sequence flow 400 of FIGS. 4A and 4B, taken from the perspective of the server 115 and/or 420.

Turning to FIG. 8, method 800 may include, at operation 805, receiving, by a server (e.g., server 115, 206, 306, 420, or 515 of FIGS. 1-5, or the like) from an untrusted device (e.g., untrusted device 110, 204, 304, 410, or 510 of FIGS. 1-5, or the like), an initial request for a high entropy key. The initial request may include a device name of the untrusted device. At operation 810, in response to receiving the initial request, the server may send, to the untrusted device, a transfer ID. Method 800 may further include receiving, by the server and from an untrusted device, a first request for a key exchange with a trusted device (e.g., trusted device 105, 202, 302, 415, or 505 of FIGS. 1-5, or the like) (at operation 815). The first request may include a transfer ID and a cryptographic hash of a second ephemeral public key. The second ephemeral public key may be generated by the untrusted device as a second key pair with a second ephemeral private key. At operation 820, the server may receive, from the trusted device, a second request for a key exchange with the untrusted device. In response to receiving the second request, the server may send, to the trusted device, the transfer ID and the cryptographic hash of the second ephemeral public key (at operation 825). In some examples, the second request may include an account email address associated with a user (e.g., user 405 of FIGS. 4A and 4B, or the like). In some cases, the device name of the untrusted device may be sent to the trusted device in response to the second request. Method 800 either may continue onto the process at operation 830 or may skip the process at operation 830 and may continue onto the process at operation 835.

At operation 830, the server may send, to each of the untrusted device and the trusted device, a blind shared secret (e.g., blind shared secret 525). In some cases, one or more common codes among a plurality of common codes may be derived from the cryptographic hash of the second ephemeral public key (from operation 825 or operation 850) and/or derived from the blind shared secret (from operation 830). In some examples, one of the untrusted device or the trusted device may display a prompt to the user to input at least one common code that may be displayed on the other of the untrusted device or the trusted device. In some instances, the plurality of common codes may include at least one of words, alphanumeric codes, or random codes, and/or the like.

Alternatively or additionally, the server may receive, from the trusted device, a third request to send a first ephemeral public key to the untrusted device (at operation 835). The third request may include the first ephemeral public key and the transfer ID. In response to receiving the third request, the server may send, to the untrusted device, the first ephemeral public key (at operation 840). The method 800 may further include, at operation 845, receiving, by the server and from the untrusted device, a fourth request to send a second ephemeral public key to the trusted device. The fourth request may include the second ephemeral public key and the transfer ID. In response to receiving the fourth request, the server may send, to the trusted device, the second ephemeral public key (at operation 850). At operation 855, the server may receive, from the trusted device, an encrypted high entropy key that is encrypted by the trusted device using a first instance of a symmetric key, in some cases, using an encryption system (e.g., encryption and/or decryption system 130 of FIG. 1, or the like). The server may send, to the untrusted device, the encrypted high entropy key (at operation 860). In examples, the first instance of the symmetric key may be generated by using a first ephemeral private key and the second ephemeral public key after verification of the untrusted device. In some cases, the encrypted high entropy key may be decryptable to obtain the high entropy key by using a second instance of the symmetric key that may be generated by the untrusted device using the first ephemeral public key and the second ephemeral private key. In some instances, the encrypted high entropy key may be decrypted by the untrusted device using a decryption system (e.g., encryption and/or decryption system 170 of FIG. 1, or the like).

In some examples, a comparison, by the trusted device, of the cryptographic hash of the second ephemeral public key and a hash of the second ephemeral public key that may be performed by the trusted device may be used to verify the second ephemeral public key as the one being committed at the beginning of the flow. In examples, the cryptographic hash of the second ephemeral public key may be generated by the untrusted device based on a cryptographic hash function. In some cases, the cryptographic hash function may include a SHA. In some instances, the hash of the second ephemeral public key that may be performed by the trusted device may be based on the cryptographic hash function including the SHA.

While the techniques and procedures in methods 600, 700, and 800 are depicted and/or described in a certain order for purposes of illustration, it should be appreciated that certain procedures may be reordered and/or omitted within the scope of various embodiments. Moreover, while the methods 600, 700, and 800 may be implemented by or with (and, in some cases, are described below with respect to) the systems, examples, or embodiments 100, 200, 300, 400, and 500A-500D of FIGS. 1, 2, 3, 4A-4B, and 5A-5D, respectively (or components thereof), such methods may also be implemented using any suitable hardware (or software) implementation. Similarly, while each of the systems, examples, or embodiments 100, 200, 300, 400, and 500A-500D of FIGS. 1, 2, 3, 4A-4B, and 5A-5D, respectively (or components thereof), can operate according to the methods 600, 700, and 800 (e.g., by executing instructions embodied on a computer readable medium), the systems, examples, or embodiments 100, 200, 300, 400, and 500A-500D of FIGS. 1, 2, 3, 4A-4B, and 5A-5D can each also operate according to other modes of operation and/or perform other suitable procedures.

### Exemplary System and Hardware Implementation

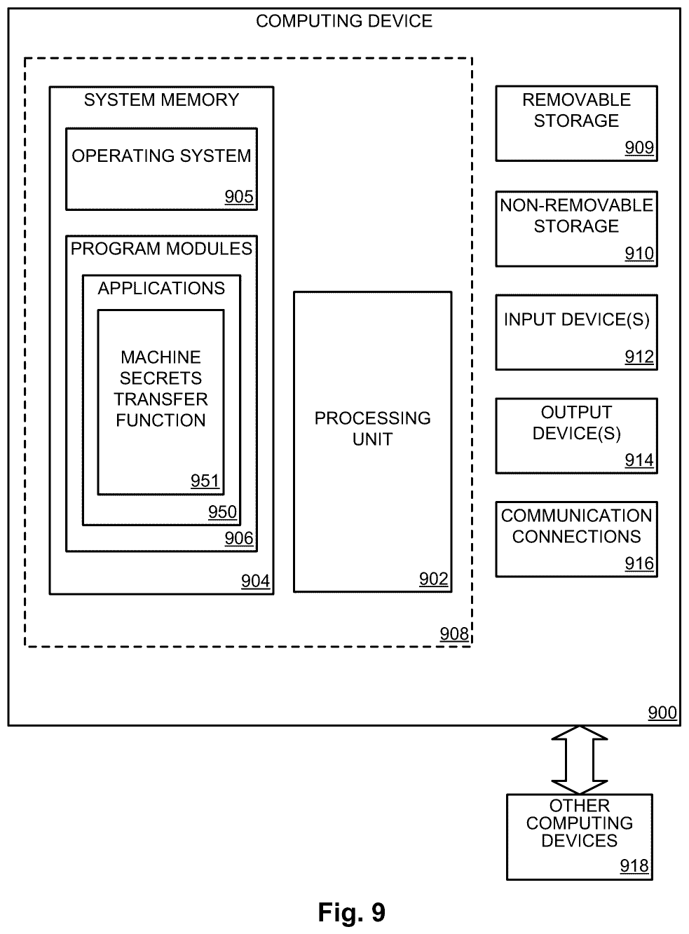

FIG. 9 depicts a block diagram illustrating physical components (i.e., hardware) of a computing device 900 with which examples of the present disclosure may be practiced. The computing device components described below may be suitable for a client device implementing the transfer of high entropy keys (e.g., machine-generated secrets), as discussed above. In a basic configuration, the computing device 900 may include at least one processing unit 902 and a system memory 904. The processing unit(s) (e.g., processors) may be referred to as a processing system. Depending on the configuration and type of computing device, the system memory 904 may include volatile storage (e.g., random access memory), non-volatile storage (e.g., read-only memory), flash memory, or any combination of such memories. The system memory 904 may include an operating system 905 and one or more program modules 906 suitable for running software applications 950, such as machine secrets transfer function 951, to implement one or more of the systems or methods described above.

The operating system 905, for example, may be suitable for controlling the operation of the computing device 900. Furthermore, aspects of the invention may be practiced in conjunction with a graphics library, other operating systems, or any other application program and is not limited to any particular application or system. This basic configuration is illustrated in FIG. 9 by those components within a dashed line 908. The computing device 900 may have additional features or functionalities. For example, the computing device 900 may also include additional data storage devices (which may be removable and/or non-removable), such as, for example, magnetic disks, optical disks, or tape. Such additional storage is illustrated in FIG. 9 by a removable storage device(s) 909 and a non-removable storage device(s) 910.

As stated above, a number of program modules and data files may be stored in the system memory 904. While executing on the processing unit 902, the program modules 906 may perform processes including one or more of the operations of the method(s) as illustrated in FIGS. 6-8, or one or more operations of the system(s) and/or apparatus(es) as described with respect to FIGS. 1-5, or the like. Other program modules that may be used in accordance with examples of the present disclosure may include applications such as electronic mail and contacts applications, word processing applications, spreadsheet applications, database applications, slide presentation applications, drawing or computer-aided application programs, artificial intelligence (“AI”) applications and machine learning (“ML”) modules on cloud-based systems, etc.

Furthermore, examples of the present disclosure may be practiced in an electrical circuit including discrete electronic elements, packaged or integrated electronic chips containing logic gates, a circuit utilizing a microprocessor, or on a single chip containing electronic elements or microprocessors. For example, examples of the present disclosure may be practiced via a system-on-a-chip (“SOC”) where each or many of the components illustrated in FIG. 9 may be integrated onto a single integrated circuit. Such an SOC device may include one or more processing units, graphics units, communications units, system virtualization units and various application functionalities all of which may be integrated (or “burned”) onto the chip substrate as a single integrated circuit. When operating via an SOC, the functionality, described herein, with respect to generating suggested queries, may be operated via application-specific logic integrated with other components of the computing device 900 on the single integrated circuit (or chip). Examples of the present disclosure may also be practiced using other technologies capable of performing logical operations such as, for example, AND, OR, and NOT, including, but not limited to, mechanical, optical, fluidic, and/or quantum technologies.

The computing device 900 may also have one or more input devices 912 such as a keyboard, a mouse, a pen, a sound input device, and/or a touch input device, etc. The output device(s) 914 such as a display, speakers, and/or a printer, etc. may also be included. The aforementioned devices are examples and others may be used. The computing device 900 may include one or more communication connections 916 allowing communications with other computing devices 918. Examples of suitable communication connections 916 include, but are not limited to, radio frequency (“RF”) transmitter, receiver, and/or transceiver circuitry; universal serial bus (“USB”), parallel, and/or serial ports; and/or the like.

The term “computer readable media” as used herein may include computer storage media. Computer storage media may include volatile and nonvolatile, and/or removable and non-removable, media that may be implemented in any method or technology for storage of information, such as computer readable instructions, data structures, or program modules. The system memory 904, the removable storage device 909, and the non-removable storage device 910 are all computer storage media examples (i.e., memory storage). Computer storage media may include random access memory (“RAM”), read-only memory (“ROM”), electrically erasable programmable read-only memory (“EEPROM”), flash memory or other memory technology, compact disk read-only memory (“CD-ROM”), digital versatile disks (“DVD”) or other optical storage, magnetic cassettes, magnetic tape, magnetic disk storage or other magnetic storage devices, or any other article of manufacture which can be used to store information and which can be accessed by the computing device 900. Any such computer storage media may be part of the computing device 900. Computer storage media may be non-transitory and tangible, and computer storage media do not include a carrier wave or other propagated data signal.

Communication media may be embodied by computer readable instructions, data structures, program modules, or other data in a modulated data signal, such as a carrier wave or other transport mechanism, and may include any information delivery media. The term “modulated data signal” may describe a signal that has one or more characteristics that are set or changed in such a manner as to encode information in the signal. By way of example, and not limitation, communication media may include wired media such as a wired network or direct-wired connection, and wireless media such as acoustic, RF, infrared, and other wireless media.

In this detailed description, wherever possible, the same reference numbers are used in the drawing and the detailed description to refer to the same or similar elements. In some instances, a sub-label is associated with a reference numeral to denote one of multiple similar components. When reference is made to a reference numeral without specification to an existing sub-label, it is intended to refer to all such multiple similar components. In some cases, for denoting a plurality of components, the suffixes “a” through “n” may be used, where n denotes any suitable non-negative integer number (unless it denotes the number 14, if there are components with reference numerals having suffixes “a” through “m” preceding the component with the reference numeral having a suffix “n”), and may be either the same or different from the suffix “n” for other components in the same or different figures. For example, for component #1 X05a-X05n, the integer value of n in X05n may be the same or different from the integer value of n in X10n for component #2 X10a-X10n, and so on. In other cases, other suffixes (e.g., s, t, u, v, w, x, y, and/or z) may similarly denote non-negative integer numbers that (together with n or other like suffixes) may be either all the same as each other, all different from each other, or some combination of same and different (e.g., one set of two or more having the same values with the others having different values, a plurality of sets of two or more having the same value with the others having different values).

Unless otherwise indicated, all numbers used herein to express quantities, dimensions, and so forth used should be understood as being modified in all instances by the term “about.” In this application, the use of the singular includes the plural unless specifically stated otherwise, and use of the terms “and” and “or” means “and/or” unless otherwise indicated. Moreover, the use of the term “including,” as well as other forms, such as “includes” and “included,” should be considered non-exclusive. Also, terms such as “element” or “component” encompass both elements and components including one unit and elements and components that include more than one unit, unless specifically stated otherwise.

In this detailed description, for the purposes of explanation, numerous specific details are set forth to provide a thorough understanding of the described embodiments. It will be apparent to one skilled in the art, however, that other embodiments of the present invention may be practiced without some of these specific details. In other instances, certain structures and devices are shown in block diagram form. While aspects of the technology may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the detailed description does not limit the technology, but instead, the proper scope of the technology is defined by the appended claims. Examples may take the form of a hardware implementation, or an entirely software implementation, or an implementation combining software and hardware aspects. Several embodiments are described herein, and while various features are ascribed to different embodiments, it should be appreciated that the features described with respect to one embodiment may be incorporated with other embodiments as well. By the same token, however, no single feature or features of any described embodiment should be considered essential to every embodiment of the invention, as other embodiments of the invention may omit such features. The detailed description is, therefore, not to be taken in a limiting sense.

Aspects of the present invention, for example, are described above with reference to block diagrams and/or operational illustrations of methods, systems, and computer program products according to aspects of the invention. The functions and/or acts noted in the blocks may occur out of the order as shown in any flowchart. For example, two blocks shown in succession may in fact be executed substantially concurrently or the blocks may sometimes be executed in the reverse order, depending upon the functionalities and/or acts involved. Further, as used herein and in the claims, the phrase “at least one of element A, element B, or element C” (or any suitable number of elements) is intended to convey any of: element A, element B, element C, elements A and B, elements A and C, elements B and C, and/or elements A, B, and C (and so on).

The description and illustration of one or more aspects provided in this application are not intended to limit or restrict the scope of the invention as claimed in any way. The aspects, examples, and details provided in this application are considered sufficient to convey possession and enable others to make and use the best mode of the claimed invention. The claimed invention should not be construed as being limited to any aspect, example, or detail provided in this application. Regardless of whether shown and described in combination or separately, the various features (both structural and methodological) are intended to be selectively rearranged, included, or omitted to produce an example or embodiment with a particular set of features. Having been provided with the description and illustration of the present application, one skilled in the art may envision variations, modifications, and alternate aspects, examples, and/or similar embodiments falling within the spirit of the broader aspects of the general inventive concept embodied in this application that do not depart from the broader scope of the claimed invention.

What is claimed is:

1. A method for transferring a high entropy key, comprising:
generating, by a trusted device, a first key pair including a first ephemeral public key and a first ephemeral private key;
capturing, by a camera of the trusted device, a graphic code that is based on a second ephemeral public key and that is displayed by an untrusted device;
extracting, by the trusted device, the second ephemeral public key from the graphic code;
generating, by the trusted device, a first instance of a symmetric key based on the first ephemeral private key and the second ephemeral public key;
encrypting, by the trusted device, a high entropy key with the first instance of the symmetric key; and
sending, by the trusted device, the encrypted high entropy key and the first ephemeral public key to a server for transfer to the untrusted device.

2. The method of claim 1, wherein the graphic code includes one of a linear barcode or a quick response (“QR”) code.

3. The method of claim 1, wherein the graphic code is displayed on a display screen, wherein the display screen is either integrated with the untrusted device or external, yet communicatively coupled, to the untrusted device.

4. The method of claim 1, wherein the encrypted high entropy key is decryptable to obtain the high entropy key by using a second instance of the symmetric key that is generated by the untrusted device using the first ephemeral public key and a second ephemeral private key, wherein the second ephemeral private key and the second ephemeral public key were generated by the untrusted device as a second key pair.

5. The method of claim 4, wherein each of the first instance of the symmetric key and the second instance of the symmetric key is generated using one of a Diffie-Hellman key exchange algorithm, an elliptic-curve Diffie-Hellman (“ECDH”) key agreement algorithm, an authenticated key exchange (“AKE”) algorithm, or another key-agreement algorithm.

6. The method of claim 1, wherein the second ephemeral public key is displayed together with a user identifier.

7. The method of claim 6, wherein the user identifier includes a user email or user identification information.

8. A method, comprising:
generating, by a trusted device, a first key pair including a first ephemeral public key and a first ephemeral private key;
sending, by the trusted device and to a server, a request for a second ephemeral public key that is generated by the untrusted device;
receiving, by the trusted device and from the server, the second ephemeral public key;
receiving, by the trusted device and through a user interface, a user input including a first code;
decoding, by the trusted device, the first code to obtain the second ephemeral public key;
performing one of:
a first comparison, by the trusted device, of the second ephemeral public key received from the server with the second ephemeral public key that is decoded from the first code; or
a second comparison, by the trusted device, of the first code with a second code derived from a user identifier and the second ephemeral public key that is received from the server;
after obtaining a match for the one of the first comparison or the second comparison, generating, by the trusted device, a first instance of a symmetric key based on the first ephemeral private key and the second ephemeral public key;
encrypting, by the trusted device, a high entropy key with the first instance of the symmetric key; and
sending, by the trusted device, the encrypted high entropy key to the server for transfer to the untrusted device.

9. The method of claim 8, further comprising:
generating, by the trusted device, a graphic code that is based on the first ephemeral public key and the user identifier;
displaying, by the trusted device, the graphic code for capture by a camera of an untrusted device;
wherein the user identifier includes a user email or user identification information, wherein the graphic code includes one of a linear barcode or a quick response (“QR”) code.

10. The method of claim 8, wherein sending the request for the second ephemeral public key includes requesting the second ephemeral public key using a long polling-based real-time communication between the trusted device and the server.

11. The method of claim 8, wherein the first code corresponds to a second code that is generated by the untrusted device based on the user identifier and the second ephemeral public key and that is displayed by the untrusted device, wherein the second code is one of a word, an alphanumeric code, or a random code.

12. The method of claim 11, wherein the alphanumeric code includes a multiple-digit code.

13. The method of claim 8, wherein the encrypted high entropy key is decryptable to obtain the high entropy key by using a second instance of the symmetric key that is generated by the untrusted device using the first ephemeral public key and a second ephemeral private key, wherein the second ephemeral private key and the second ephemeral public key were generated by the untrusted device as a second key pair.

14. The method of claim 13, wherein each of the first instance of the symmetric key and the second instance of the symmetric key is generated using one of a Diffie-Hellman key exchange algorithm, an elliptic-curve Diffie-Hellman (“ECDH”) key agreement algorithm, an authenticated key exchange (“AKE”) algorithm, or another key-agreement algorithm.

15. A server, comprising:
a processing system; and
memory coupled to the processing system, the memory comprising computer executable instructions that, when executed by the processing system, causes the server to perform operations comprising:
receiving, from an untrusted device, a first request for a key exchange with a trusted device, the first request including a transfer identifier (“ID”) and a cryptographic hash of a second ephemeral public key, the second ephemeral public key being generated by the untrusted device as a second key pair with a second ephemeral private key;
receiving, from the trusted device, a second request for a key exchange with the untrusted device;
in response to receiving the second request, sending, to the trusted device, the transfer ID and the cryptographic hash of the second ephemeral public key;
receiving, from the trusted device, a third request to send a first ephemeral public key to the untrusted device, the third request including the first ephemeral public key and the transfer ID;
in response to receiving the third request, sending, to the untrusted device, the first ephemeral public key;
receiving, from the untrusted device, a fourth request to send a second ephemeral public key to the trusted device, the fourth request including the second ephemeral public key and the transfer ID;
in response to receiving the fourth request, sending, to the trusted device, the second ephemeral public key;
receiving, from the trusted device, an encrypted high entropy key that is encrypted by the trusted device using a first instance of a symmetric key; and
sending, to the untrusted device, the encrypted high entropy key.

16. The server of claim 15, wherein the first instance of the symmetric key is generated by using a first ephemeral private key and the second ephemeral public key after verification of the untrusted device, wherein the encrypted high entropy key is decryptable to obtain a high entropy key by using a second instance of the symmetric key that is generated by the untrusted device using the first ephemeral public key and the second ephemeral private key.

17. The server of claim 15, wherein a comparison, by the trusted device, of the cryptographic hash of the second ephemeral public key and a hash of the second ephemeral public key that is performed by the trusted device is used to verify the untrusted device.

18. The server of claim 17, wherein the cryptographic hash of the second ephemeral public key is generated by the untrusted device based on a cryptographic hash function, wherein the cryptographic hash function includes a secure hash algorithm (“SHA”), wherein the hash of the second ephemeral public key that is performed by the trusted device is based on the cryptographic hash function including the SHA.

19. The server of claim 15, wherein the operations further comprise, prior to receiving the first request:
receiving, from the untrusted device, an initial request for a high entropy key, the initial request including a device name of the untrusted device; and
in response to receiving the initial request, sending, to the untrusted device, the transfer ID;
wherein the second request includes an account email address, and wherein the device name of the untrusted device is sent to the trusted device in response to the second request.

20. The server of claim 15, wherein the operations further comprise:
sending, to each of the untrusted device and the trusted device, a blind shared secret, one or more common codes among a plurality of common codes being derived from the blind shared secret, wherein one of the untrusted device or the trusted device displays a prompt to a user to input at least one common code that is displayed on the other of the untrusted device or the trusted device, wherein the plurality of common codes includes at least one of words, alphanumeric codes, or random codes.
